(19) United States
(12) Patent Application Publication
(10) Pub. No.: US 2024/0154638 A1
(43) Pub. Date: May 9, 2024

(54) RETROREFLECTIVE SAFETY DEVICE AND METHOD

(71) Applicant: CORNING INCORPORATED, CORNING, NY (US)

(72) Inventor: Santanu Basu, Palo Alto, CA (US)

(21) Appl. No.: 18/385,477

(22) Filed: Oct. 31, 2023

Related U.S. Application Data
(60) Provisional application No. 63/422,028, filed on Nov. 3, 2022.

(51) Int. Cl. H04B 1/3888; G02B 1/00; G02B 5/12

(52) U.S. Cl. CPC H04B 1/3888; G02B 1/002; G02B 5/12

(57) ABSTRACT

A retroreflective safety device can include a body coupled to a mobile device. A metasurface, disposed on a surface of the body, can include a plurality of nanostructures arranged to retroreflect light that strikes the metasurface. Each nanostructure of the plurality of nanostructures can be smaller than a wavelength of the light. In some examples, a retroreflective safety device can include a body having a first exterior surface and a second exterior surface angled with respect to the first exterior surface. A first metasurface, disposed on the first exterior surface, can include a first plurality of nanostructures arranged to retroreflect light that strikes the first metasurface. A second metasurface, disposed on the second exterior surface, can include a second plurality of nanostructures arranged to retroreflect light that strikes the second metasurface.

### CROSS-REFERENCE TO RELATED APPLICATIONS

This application claims the benefit of priority under 35 U.S.C. § 119 of U.S. Provisional Application No. 63/422,028 filed Nov. 3, 2022, the content of which is incorporated herein by reference in its entirety.

### FIELD OF THE DISCLOSURE

The present disclosure relates generally to retroreflective optical elements.

### BACKGROUND OF THE DISCLOSURE

There is ongoing effort to expand the utility of a mobile device, such as a smart phone or a tablet computer.

### SUMMARY

In an example, a retroreflective safety device can include: a body coupled to a mobile device; and a metasurface disposed on a surface of the body, the metasurface including a plurality of nanostructures arranged to retroreflect light that strikes the metasurface, each nanostructure of the plurality of nanostructures being smaller than a wavelength of the light.

In an example, a method for generating a retroreflective safety device can include: disposing a first metasurface on a first exterior surface of a body, the first metasurface including a first plurality of nanostructures arranged to retroreflect light that strikes the first metasurface; and disposing a second metasurface on a second exterior surface of the body, the second exterior surface being angled with respect to the first exterior surface, the second metasurface including a second plurality of nanostructures arranged to retroreflect light that strikes the second metasurface.

In an example, a retroreflective safety device can include: a body including a first exterior surface and a second exterior surface that is angled with respect to the first exterior surface; a first metasurface disposed on the first exterior surface, the first metasurface including a first plurality of nanostructures arranged to retroreflect light that strikes the first metasurface; and a second metasurface disposed on the second exterior surface, the second metasurface including a second plurality of nanostructures arranged to retroreflect light that strikes the second metasurface.

### BRIEF DESCRIPTION OF THE DRAWINGS

FIG. 1 shows a perspective view of an example of a retroreflective safety device.

FIG. 2 shows a side view of the retroreflective safety device of FIG. 1, in the presence of incident light.

FIG. 3 shows a side view of the retroreflective safety device of FIG. 1, in the presence of reflected light.

FIG. 4 shows a top view of an example of a metasurface on an exterior surface of a retroreflective safety device.

FIG. 5 shows a top view of an example of a metasurface on an exterior surface of a retroreflective safety device.

FIG. 6 shows a cross-sectional side view of an example of a metasurface on an exterior surface of a retroreflective safety device.

FIG. 7 shows a flow chart for an example of a method for generating a retroreflective safety device.

FIG. 8 shows a flow chart for an example of a method for operating a retroreflective safety device.

### DETAILED DESCRIPTION

A retroreflective safety device can include a body coupled to a mobile device. A metasurface, disposed on a surface of the body, can include a plurality of nanostructures arranged to retroreflect light that strikes the metasurface. In retroreflection, a reflected light ray is reflected in the direction from which it came, as distinguished from a standard mirror. Each nanostructure of the plurality of nanostructures can be smaller than a wavelength of the light. For light in the visible portion of the electromagnetic spectrum, having wavelengths between about 400 nm and about 700 nm, each nanostructure can be smaller than 700 nm. In some examples, a retroreflective safety device can include a body having a first exterior surface and a second exterior surface angled with respect to the first exterior surface. A first metasurface, disposed on the first exterior surface, can include a first plurality of nanostructures arranged to retroreflect light that strikes the first metasurface. A second metasurface, disposed on the second exterior surface, can include a second plurality of nanostructures arranged to retroreflect light that strikes the second metasurface.

Disposing a retroreflector on a body associated with the mobile device, such as being part of the mobile device (as with a body integrally formed with the device) or coupled to the mobile device (as with a body that encases the mobile device), can allow the mobile device itself to function as a retroreflector without consuming any electrical power, and without requiring that the mobile device be powered on or connected via a wireless connection.

Using a mobile device as a retroreflector can be beneficial in the event of an emergency, such as when a person has a smart phone but little else in the person's possession. For example, a person at the side of a dark road may be able to position the mobile device to receive oncoming headlights from a vehicle. The retroreflector can shine a portion of the headlights directly back toward a driver of the vehicle to alert the driver of the person's presence.

Further, disposing retroreflecting metasurfaces on two or more surfaces of a body, such as a mobile device, can provide additional safety. For example, a person engrossed in a smart phone screen may enter a crosswalk of a street without first checking for vehicular traffic in the street. A retroreflector on a side of the mobile device (e.g., a side that is orthogonal to the screen of the mobile device) can retroreflect headlights from a vehicle approaching the person to alert the driver of the presence of the person in the crosswalk. As another example, an investigator investigating an accident scene can shine vehicle headlights or a flashlight toward the scene. The mobile device, whether held by a victim of the accident or located away from the victim, can reflect a portion of the vehicle headlights or flashlight beam back toward the investigator, which can alert the investigator to the presence of the victim. Because the retroreflecting metasurfaces can be disposed on multiple surfaces of the mobile device (e.g., on all surfaces of the mobile device), the mobile device can retroreflect some light toward the investigator, regardless of orientation of the mobile device.

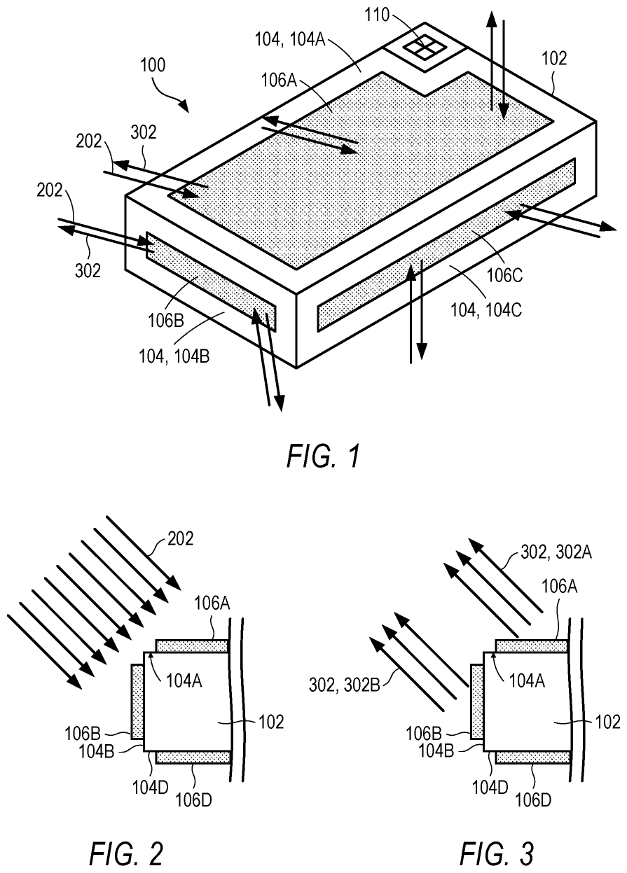

FIG. 1 shows a perspective view of an example of a retroreflective safety device 100.

The retroreflective safety device 100 includes a body 102 that can be coupled to a mobile device.

In some examples, the body 102 can be integrally formed with the mobile device. For example, the mobile device can be a smart phone, and the body 102 can include one or more exterior surfaces that are exterior surfaces of the smart phone. For example, the body 102 can include one or more surfaces of a housing of the mobile device. The housing can hold electrical circuitry and other functional components of the mobile device.

In other examples, the body 102 can be removably coupled to the mobile device. For example, the body 102 can be shaped as a case to removably attach to the smart phone, such as by surrounding the housing of the mobile device. Because light can retroreflect from a feature at or on the surface of the body 102 and does not penetrate a significant distance into the body 102 beyond a depth of the feature, the body 102 may be formed from a transparent material or an opaque material. In some examples, the body 102 can include at least one of a glass material, a ceramic material, or a glass ceramic material. Other suitable materials can also be used.

The body 102 can include exterior surfaces 104, including a first exterior surface 104A and a second exterior surface 104B that is angled with respect to the first exterior surface 104A. In some examples, such as for mobile devices that are shaped as cuboids (e.g., in which adjacent exterior surfaces 104 are orthogonal or generally orthogonal, optionally with a rounding or beveling between adjacent exterior surfaces 104), the second exterior surface 104B can be orthogonal or generally orthogonal to the first exterior surface 104A.

The retroreflective safety device 100 can include a metasurface 106 disposed on a surface of the body 102, including a first metasurface 106A disposed on the first exterior surface 104A, a second metasurface 106B disposed on the second exterior surface 104B, and a third metasurface 106C disposed on a third exterior surface 104C. In some examples, each exterior surface 104 of the body 102 can include a respective metasurface 106 disposed on the exterior surface 104.

Each metasurface 106 can include a respective plurality of nanostructures arranged to retroreflect light that strikes the metasurface 106. Each nanostructure of the plurality of nanostructures can be smaller than a wavelength of the light. For wavelengths in the visible portion of the electromagnetic spectrum, in the range between 400 nm and 700 nm, at least some of the nanostructures can be smaller than 400 nm.

In some embodiments the light wavelength may be within the typical LIDAR sensor wavelength range, for example: about 905 nm (e.g., 900-910 nm) or about 1550 nm (i.e., 1545-1555 nm). In these embodiments each nanostructure of the plurality of nanostructures can be smaller than 905 nm (for LIDAR wavelength of 905 nm) or smaller than smaller than 1550 nm.

In some examples, the plurality of nanostructures can include at least one of silicon nanoposts, at least one patterned layer of silicon nitride, or at least one patterned layer of silicon dioxide. Other suitable nanostructures can be used as well.

In some examples, the first metasurface 106A can include a first plurality of nanostructures arranged to retroreflect light that strikes the first metasurface 106A. The second metasurface 106B can include a second plurality of nanostructures arranged to retroreflect light that strikes the second metasurface 106B. In some examples, for at least some propagation directions of incident light that strikes the body 102, a first portion of the incident light can retroreflect from the first metasurface 106A and a second portion of the incident light can simultaneously retroreflect from the second metasurface 106B.

FIG. 2 shows a side view of the retroreflective safety device 100 of FIG. 1, in the presence of incident light 202. The body 102 includes the first metasurface 106A disposed on the first exterior surface 104A, the second metasurface 106B disposed on the second exterior surface 104B, and a fourth metasurface 106D disposed on a fourth exterior surface 104D. Incident light 202 can simultaneously strike the first metasurface 106A on the first exterior surface 104A and the second metasurface 106B on the second exterior surface 104B.

FIG. 3 shows a side view of the retroreflective safety device 100 of FIG. 1, in the presence of reflected light 302. A first portion of the incident light 202 can retroreflect from the first metasurface 106A as first reflected portion 302A. A second portion of the incident light 202 can retroreflect from the second metasurface 106B as second reflected portion 302B. The first and second portions of the incident light 202 can retroreflect simultaneously.

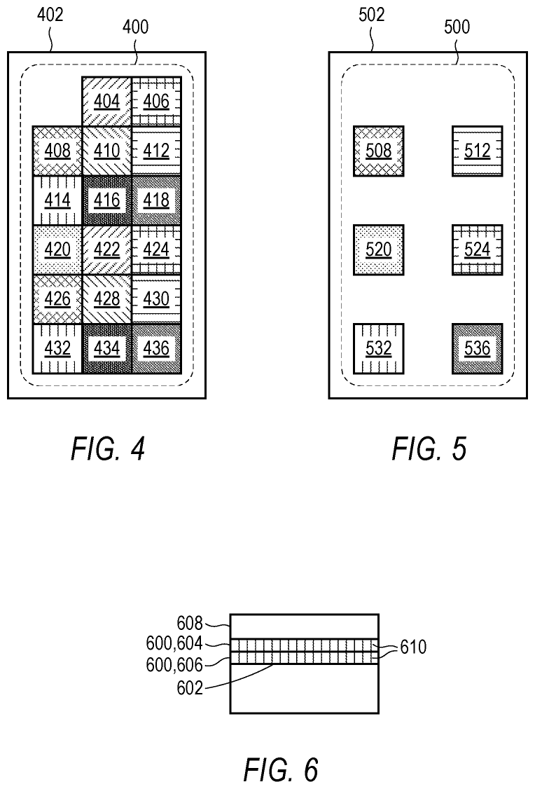

FIG. 4 shows a top view of an example of a metasurface 400 on an exterior surface 402 of a retroreflective safety device, such as the retroreflective safety device 100 of FIG. 1. In some examples, the metasurface 400 can be disposed on a contiguous area of a body of the retroreflective safety device. In the example of FIG. 4, the metasurface 400 includes metasurface portions 404, 406, 408, 410, 412, 414, 416, 418, 420, 422, 424, 426, 428, 430, 432, 434, and 436, which are disposed on a contiguous area on the exterior surface 402 of the body.

FIG. 5 shows a top view of an example of a metasurface 500 on an exterior surface 502 of a retroreflective safety device, such as the retroreflective safety device 100 of FIG. 1. In some examples, the metasurface 500 can be disposed on a plurality of non-contiguous areas of the body. In the example of FIG. 5, the metasurface 500 includes metasurface portions 508, 512, 520, 524, 532, and 536, which are disposed on non-contiguous areas on the exterior surface 502 of the body.

In some examples, the nanostructures of different metasurfaces and/or in different portions of a single metasurface can be tuned or designed for particular wavelength ranges and/or particular incident angle ranges.

For example, a metasurface can include a metasurface portion including a first plurality of nanostructures that are arranged to retroreflect light having a first range of wavelengths. The metasurface can further include a second metasurface portion including a second plurality of nanostructures that are arranged to retroreflect light having a second range of wavelengths different from the first range of wavelengths. As another example, a metasurface can include a first metasurface portion including a first plurality of nanostructures that are arranged to retroreflect light having a first range of incident angles. The metasurface can further include a second metasurface portion including a second plurality of nanostructures that are arranged to retroreflect light having a second range of incident angles different from the first range of incident angles. As a specific example, a metasurface can include a first metasurface portion that is tuned or designed to retroreflect red light (with light away from the red portion of the electromagnetic spectrum reflecting more weakly and/or reflecting at angles that are away from retroreflection), a second metasurface portion that is tuned or designed to retroreflect green light (with light away from the green portion of the electromagnetic spectrum reflecting more weakly and/or reflecting at angles that are away from retroreflection), and a third metasurface portion that is tuned or designed to retroreflect blue light (with light away from the blue portion of the electromagnetic spectrum reflecting more weakly and/or reflecting at angles that are away from retroreflection). Designing and generating the metasurface portions to have optimal performance at different wavelengths and/or different incident angle ranges can help ensure that at least some incident light that strikes the body will be strongly retroreflected. At least some of the metasurface portions can be contiguous. At least some of the metasurface portions can be non-contiguous.

In some examples, the metasurface can be disposed on a plurality of noncontiguous areas of the body. In some examples, two more metasurface portions can be disposed on a same surface (e.g., planar surface) of the body. In some examples, two more metasurface portions can be disposed on different surfaces (e.g., planar surfaces that are angled with respect to each other) of the body.

FIG. 6 shows a cross-sectional side view of an example of a metasurface 600 on an exterior surface 602 of a retroreflective safety device, such as the retroreflective safety device 100 of FIG. 1.

In some examples, the metasurface 600 can include a first planar metasurface layer 604 and a second planar metasurface layer 606 disposed between the first planar metasurface layer 604 and the body 102. The first planar metasurface layer 604 and the second planar metasurface layer 606 include nanostructures but are referred to as being planar because on a macro scale that is significantly larger than the size of the nanostructures and the wavelength of the retroreflected light, the first planar metasurface layer 604 and the second planar metasurface layer 606 are formed are generally flat layers on a generally flat exterior surface 602 of the body.

The first planar metasurface layer 604 can perform a spatial Fourier transform of incident light to form transformed light. The second planar metasurface layer 606 can impart a spatially varying momentum to the transformed light to form reflected transformed light. The first planar metasurface layer 604 can further perform a spatial inverse Fourier transform of the reflected transformed light to form reflected light. The reflected light can exit the metasurface 600 in a direction that is opposite that of the incident light. This is but one example of a structure for the metasurface 600 that can retroreflect light. Other suitable structures can also be used.

In examples in which the mobile device is a smart phone, the metasurface 600 can be spaced apart from a screen of the smart phone. In examples in which the mobile device is a smart phone, the metasurface 600 can be spaced apart from a camera 110 (FIG. 1) of the smart phone. In some examples, one or more metasurfaces 600 can be disposed on one or more surfaces of a mobile device, such as a smart phone or a tablet computer. The retroreflector can be formed using one or more metasurfaces 600. The retroreflector can be disposed on a ceramic material, a glass material, a glass ceramic material, or another suitable material. The retroreflector can be disposed on a cover glass of the mobile device. The retroreflector can be disposed on a screen protector of the mobile device. The retroreflector can be disposed on a front cover of the mobile device. The retroreflector can be disposed on a back cover of the mobile device.

In some examples, the retroreflective safety device can further include a protective layer 608 disposed on the metasurface 600. The protective layer 608 can be transparent for wavelengths in the visible spectrum. The protective layer 608 can include at least one of a polymer or silicon dioxide or another suitable material or materials.

In some examples, a metasurface 600 can optionally be patterned such that different areas of the metasurface 600 can perform different functions. For example, a first area of the metasurface 600 can function as a retroreflector. A second area of the metasurface 600 can perform a function other than retroreflecting light, such as focusing light as a lens. Other functions can also be used. The areas can be selected based on one or more constraints on the mobile device, such as the retroreflector not obscuring a viewing area of the screen of the mobile device or not obscuring a camera of the mobile device.

The metasurface 600 can be formed by lithographical methods, pattern transfer methods or by direct writing methods. In some examples, the metasurface 600 can be formed using electron-beam lithography. The metasurface formation steps may include metal evaporation, insulator deposition, spin coating resist, electron beam lithography and development, metal evaporation and lift off. For example, an electron-beam lithography machine can scan a focused beam of electrons to draw the microstructures or nanostructures on an electron-sensitive film, such as a resist, disposed on a surface of the substrate. The microstructures or nanostructures can then be transferred to the surface, such as by etching the resist into the surface of the substrate.

In some examples, the metasurface 600 can be formed using nanoimprint lithography. For example, a nanoimprint lithography machine can mechanically deform a layer of resist to include the nanostructures 610 (also referred to as microstructures). The nanostructures 610 can then be transferred to the surface, such as by etching the resist into the surface of the substrate.

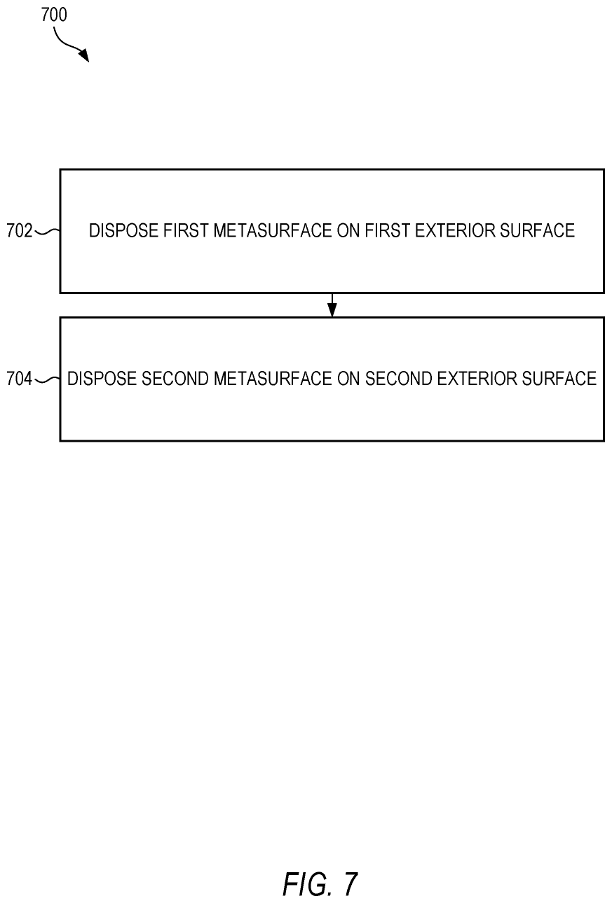

FIG. 7 shows a flow chart for an example of a method 700 for generating a retroreflective safety device, such as the retroreflective safety device 100 of FIG. 1. The method 700 is but one example of a method for generating a retroreflective safety device. Other methods can also be used.

At operation 702, a first metasurface can be disposed on a first exterior surface, such as first exterior surface 104A, of a body, such as body 102. The first metasurface can include a first plurality of nanostructures arranged to retroreflect light that strikes the first metasurface.

At operation 704, a second metasurface can be disposed on a second exterior surface, such as second exterior surface 104B, of the body. The second exterior surface can be angled with respect to the first exterior surface. The second metasurface can include a second plurality of nanostructures arranged to retroreflect light that strikes the second metasurface.

In some examples, disposing the first metasurface on the first exterior surface can include disposing a first planar metasurface layer on the first exterior surface, and disposing a second planar metasurface layer on the first planar metasurface layer. The first planar metasurface layer can perform a spatial Fourier transform of incident light to form transformed light. The second planar metasurface layer can impart a spatially varying momentum to the transformed light to form reflected transformed light. The first planar metasurface layer further can perform a spatial inverse Fourier transform of the reflected transformed light to form reflected light. The reflected light can exit the metasurface in a direction that is opposite that of the incident light.

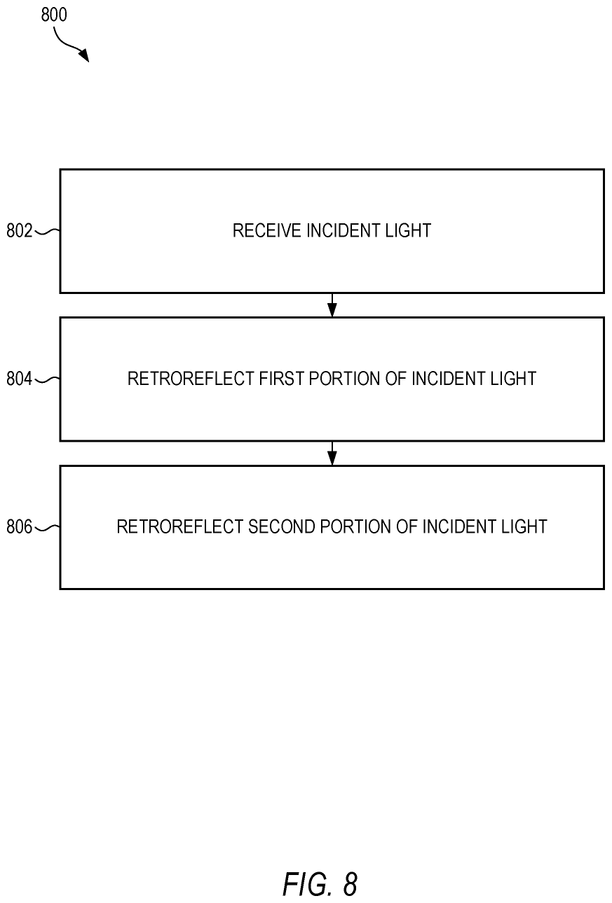

FIG. 8 shows a flow chart for an example of a method 800 for operating a retroreflective safety device, such as the retroreflective safety device 100 of FIG. 1. The method 800 is but one example of a method for operating a retroreflective safety device. Other methods can also be used.

At operation 802, incident light can be received on a body, such as body 102, that includes a first exterior surface and a second exterior surface that is angled with respect to the first exterior surface.

At operation 804, a first portion of the incident light can be retroreflecting with a first plurality of nanostructures arranged on a first metasurface. The first metasurface can be disposed on the first exterior surface. Each nanostructure of the first plurality of nanostructures can be smaller than a wavelength of the incident light.

At operation 806, a second portion of the incident light can be retroreflected with a second plurality of nanostructures arranged on a second metasurface. The second metasurface can be disposed on the second exterior surface. Each nanostructure of the second plurality of nanostructures can be smaller than the wavelength of the incident light. The first portion and the second portion can be retroreflected simultaneously.

In some examples, retroreflecting the first portion of the incident light can include performing, with a first planar metasurface layer of the first metasurface, a spatial Fourier transform of the first portion of incident light to form transformed light; imparting, with a second planar metasurface layer of the first metasurface, a spatially varying momentum to the transformed light to form reflected transformed light; and performing, with the first planar metasurface layer of the first metasurface, a spatial inverse Fourier transform of the reflected transformed light to form reflected light. In some examples, the reflected light can be directed to exit the metasurface in a direction that is opposite or approximately opposite that of the incident light. Such approximate deviations from exactly opposite can arise due to manufacturing tolerances or use at conditions that differ from the design conditions. For example, the reflected light may have a wavelength that differs from the wavelength at which the element was originally designed and may therefore reflect at a small angle away from true retroreflection. For the purposes of this document, the phrase approximately opposite can include angular deviations of 0 degrees, between 0 degrees and 0.5 degrees, between 0 degrees and 1 degree, between 0 degrees and 2 degrees, between 0 degrees and 5 degrees, all inclusive.

Although the various aspects of the present invention have been described with respect to a preferred embodiment, it will be understood that the invention is entitled to full protection within the full scope of the appended claims.

What is claimed is:

1. A retroreflective safety device, comprising:
a body coupled to a mobile device; and
a metasurface disposed on a surface of the body, the metasurface including a plurality of nanostructures arranged to retroreflect light that strikes the metasurface, each nanostructure of the plurality of nanostructures being smaller than a wavelength of the light.

2. The retroreflective safety device of claim 1, wherein:
the metasurface is a first metasurface;
the surface is a first surface;
the body further includes a second surface that is angled with respect to the first surface; and
the retroreflective safety device further comprises a second metasurface disposed on the second surface, the second metasurface including a second plurality of nanostructures arranged to retroreflect second light that strikes the second metasurface, each nanostructure of the second plurality of nanostructures being smaller than a wavelength of the second light.

3. The retroreflective safety device of claim 2, wherein the second surface is generally orthogonal to the first surface, such that for at least some propagation directions of incident light that strikes the body, a first portion of the incident light retroreflects from the first metasurface and a second portion of the incident light simultaneously retroreflects from the second metasurface.

4. The retroreflective safety device of claim 1, wherein the body is integrally formed with the mobile device.

5. The retroreflective safety device of claim 4, wherein:
the mobile device is a smart phone; and
the body is formed as an exterior surface of the smart phone.

6. The retroreflective safety device of claim 1, wherein the body is removably coupled to the mobile device.

7. The retroreflective safety device of claim 6, wherein:
the mobile device is a smart phone; and
the body is shaped as a case to removably attach to the smart phone.

8. The retroreflective safety device of claim 1, wherein the metasurface includes:
a first metasurface portion including a first plurality of nanostructures that are arranged to retroreflect light having a first range of wavelengths; and
a second metasurface portion including a second plurality of nanostructures that are arranged to retroreflect light having a second range of wavelengths different from the first range of wavelengths.

9. The retroreflective safety device of claim 1, wherein the metasurface includes:
a first metasurface portion including a first plurality of nanostructures that are arranged to retroreflect light having a first range of incident angles; and
a second metasurface portion including a second plurality of nanostructures that are arranged to retroreflect light having a second range of incident angles different from the first range of incident angles.

10. The retroreflective safety device of claim 1, wherein the metasurface is disposed on a contiguous area of the body.

11. The retroreflective safety device of claim 1, wherein the metasurface is disposed on a plurality of noncontiguous areas of the body.

12. The retroreflective safety device of claim 1, wherein:
the mobile device is a smart phone;
the metasurface is spaced apart from a screen of the smart phone; and
the metasurface is spaced apart from a camera of the smart phone.

13. The retroreflective safety device of claim 1, wherein the body includes at least one of a glass material, a ceramic material, or a glass ceramic material.

14. The retroreflective safety device of claim 1, further comprising a protective layer disposed on the metasurface, the protective layer including at least one of a polymer or silicon dioxide.

15. The retroreflective safety device of claim 1, wherein the plurality of nanostructures include at least one of silicon nanoposts, at least one patterned layer of silicon nitride, or at least one patterned layer of silicon dioxide.

16. The retroreflective safety device of claim 1, wherein the metasurface comprises a first planar metasurface layer and a second planar metasurface layer disposed between the first planar metasurface layer and the body, the first planar metasurface layer configured to perform a spatial Fourier transform of incident light to form transformed light, the second planar metasurface layer configured to impart a spatially varying momentum to the transformed light to form reflected transformed light, the first planar metasurface layer further configured to perform a spatial inverse Fourier transform of the reflected transformed light to form reflected light, the reflected light configured to exit the metasurface in a direction that is opposite that of the incident light.

17. A method for generating a retroreflective safety device, the method comprising:
disposing a first metasurface on a first exterior surface of a body, the first metasurface including a first plurality of nanostructures arranged to retroreflect light that strikes the first metasurface; and
disposing a second metasurface on a second exterior surface of the body, the second exterior surface being angled with respect to the first exterior surface, the second metasurface including a second plurality of nanostructures arranged to retroreflect light that strikes the second metasurface.

18. The method of claim 17, wherein disposing the first metasurface on the first exterior surface comprises:
disposing a first planar metasurface layer on the first exterior surface; and
disposing a second planar metasurface layer on the first planar metasurface layer,
the first planar metasurface layer configured to perform a spatial Fourier transform of incident light to form transformed light, the second planar metasurface layer configured to impart a spatially varying momentum to the transformed light to form reflected transformed light, the first planar metasurface layer further configured to perform a spatial inverse Fourier transform of the reflected transformed light to form reflected light, the reflected light configured to exit the metasurface in a direction that is opposite that of the incident light.

19. A retroreflective safety device, comprising:
a body including a first exterior surface and a second exterior surface that is angled with respect to the first exterior surface;
a first metasurface disposed on the first exterior surface, the first metasurface including a first plurality of nanostructures arranged to retroreflect light that strikes the first metasurface; and
a second metasurface disposed on the second exterior surface, the second metasurface including a second plurality of nanostructures arranged to retroreflect light that strikes the second metasurface.

20. The retroreflective safety device of claim 19, wherein for at least some propagation directions of incident light that strikes the body, a first portion of the incident light retroreflects from the first metasurface and a second portion of the incident light simultaneously retroreflects from the second metasurface.
